(19) United States
(12) Patent Application Publication
(10) Pub. No.: US 2024/0253408 A1
(43) Pub. Date: Aug. 1, 2024

(54) SEMI-TRAILER

(71) Applicant: STI Holdings, Inc., Stoughton, WI (US)

(72) Inventors: Andrew David Aleson, Edgerton, WI (US); Steven Paul Moore, Oregon, WI (US)

(21) Appl. No.: 18/426,737

(22) Filed: Jan. 30, 2024

Related U.S. Application Data
(60) Provisional application No. 63/482,145, filed on Jan. 30, 2023.

(51) Int. Cl. B60D 1/64; B62D 53/06; B62D 53/08

(52) U.S. Cl. CPC B60D 1/64; B62D 53/06; B62D 53/0842

(57) ABSTRACT

A semi-trailer including a cargo area, and an integrated fifth-wheel coupler unit extending horizontally along a front lower portion of the semi-trailer. The coupler unit includes an upper coupler surface defining a floor level of the cargo area, a lower coupler surface spaced below the upper coupler surface, and a kingpin projecting downwardly from the lower coupler surface and configured for coupling with a tow vehicle fifth wheel. A utility line connection portion is provided for establishing connections between at least one utility source of the tow vehicle and at least one utility component of the semi-trailer. The integrated fifth-wheel coupler unit includes a front wall with a recessed cavity at a central widthwise location accommodating the utility line connection portion.

### CROSS-REFERENCE TO RELATED APPLICATIONS

This application claims the benefit of priority to co-pending U.S. Provisional Patent Application No. 63/482,145, filed on Jan. 30, 2023, the entire contents of which are incorporated by reference herein.

### BACKGROUND

The invention relates to over-the-road trailers and structures therein provided for utility line connections between the trailer and a tow vehicle (e.g., road tractor) connected with and configured to pull the trailer. A conventional tractor-trailer combination is shown in FIG. 1 and includes a tractor 1020 having a power plant and a chassis, and a semi-trailer 1024 releasably coupled to the tractor 1020 and configured to be towed by the tractor 1020. The semi-trailer 1024 has a front end 1028 adapted to face the rear of the tractor 1020 when coupled for transport. Because the semi-trailer 1024 is not permanently linked with the tractor 1020 and does not have its own on-board utilities, a plurality of utility lines 1032 extend from the rear of the tractor 1020 for connection with a plurality of connectors provided at the front end 1028 of the semi-trailer 1024. The utility lines 1032 make it possible to send power and communicate control signals from the tractor 1020 to the semi-trailer 1024 for the proper functioning of the tractor/trailer combination. The utility lines 1032 can include both electrical and air lines, and the connections can optionally be made at a recessed cavity 1036 or “nosebox” in the front wall 1040 of the semi-trailer 1024 as shown in FIG. 2. From the recessed cavity 1036, additional utility lines 1078, 1088 are provided to enable air or electrical communication to an interior side of the front wall 1040 and subsequently to an underside of the semi-trailer 1024 for further routing (e.g., to lights, service brakes, parking brakes, etc.). Such arrangements are known in a variety of trailers, including the conventional dry van illustrated, which includes multiple wheeled axles at a rear portion thereof, and an upper coupler for a fifth-wheel adjacent the front end 1028.

Although the conventional standard is for the human operator to manually make utility line connections between the tractor 1020 and the semi-trailer 1024 when linking the trailer to the tractor (and subsequently manually disconnecting the utility line connections when unlinking), the industry has contemplated a number of automatic coupling systems by which structures of the tractor and the semi-trailer can be mated together for establishing functional utility line connections, without the need for direct manual operations. Some examples include U.S. patent Publication 2022/0332158, U.S. Pat. Nos. 11,260,711, 8,177,559, 8,187,020, 7,758,059, 7,793,966, 7,967,319, and 7,854,443, the entire contents of all of which are incorporated herein by reference. However, up until this point, there has been great complexity and cost involved with all prior art efforts to configure a tractor and semi-trailer for automatic utility line connection such that there is little or no proliferation of this technology.

### SUMMARY

In one aspect, the invention provides a semi-trailer including a cargo area, and an integrated fifth-wheel coupler unit extending horizontally along a front lower portion of the semi-trailer. The coupler unit includes an upper coupler surface defining a floor level of the cargo area, a lower coupler surface spaced below the upper coupler surface, and a kingpin projecting downwardly from the lower coupler surface and configured for coupling with a fifth wheel of a tow vehicle. A utility line connection portion is provided for establishing connections between at least one utility source of the tow vehicle and at least one utility component of the semi-trailer. The integrated fifth-wheel coupler unit includes a front wall with a recessed cavity at a central widthwise location accommodating the utility line connection portion.

In another aspect, the invention provides a semi-trailer including a cargo area defined between a front end a rear end for supporting cargo, and an integrated fifth-wheel coupler unit provided at a bottom of the front end and comprising a reinforced box structure and a downwardly protruding kingpin. A recessed cavity is provided entirely within the integrated fifth-wheel coupler unit and located at a lateral center plane in-line with the kingpin. A utility line connection portion that establishes one-half of an automatic utility line connection system is received within the recessed cavity.

In yet another aspect, the invention provides a semi-trailer including a cargo area including a floor, an integrated fifth-wheel coupler unit supporting the floor at a front end of the semi-trailer, and a recessed cavity provided in a front central portion of the integrated fifth-wheel coupler unit. A utility line connection portion is secured within the recessed cavity. The recessed cavity has a height of 63.5 mm (2.5 inches) or less and a width of 330 mm (13 inches) or less. The coupler unit includes a pick-up lip bent around a bottom forward edge, and an opening of the recessed cavity is formed in the front wall entirely above an upper edge of the pick-up lip.

### BRIEF DESCRIPTION OF THE DRAWINGS

FIG. 1 is a side elevation view of a tractor-trailer combination, according to a prior construction.

FIG. 2 is a perspective view of a recessed nosebox including a plurality of utility line connectors at a front end of the semi-trailer of FIG. 1.

FIG. 3 is a perspective view of a semi-trailer according to one embodiment of the present disclosure.

FIG. 4 is a bottom perspective view of a front wall and a coupler of the semi-trailer of FIG. 3.

FIG. 5 is a front view of the coupler of FIG. 4.

FIG. 6 is a detail perspective view of a central recessed portion of the coupler of FIG. 5.

FIG. 6A is a detail perspective view of an embodiment of the coupler that includes a reinforcement frame on the front wall.

FIG. 7 is a perspective view of the coupler of FIG. 4, removed from the front wall of the semi-trailer.

FIG. 8 is a perspective view of the coupler of FIG. 7, having a portion of the upper surface removed to reveal interior features thereof.

FIG. 9 is a cross-section of the coupler, taken along line 9-9 of FIG. 7.

FIG. 10 is a perspective of a semi-trailer front wall and coupler according to another embodiment of the present disclosure.

FIG. 11 is a cross-section taken through a horizontal plane below the upper surface of the coupler of FIG. 10, illustrating among other things a recessed cavity for utility line connection at a front central position.

FIG. 12 is a zoomed in front detail view of the coupler of FIGS. 10 and 11, illustrating the size and placement of the opening of the recessed cavity.

### DETAILED DESCRIPTION

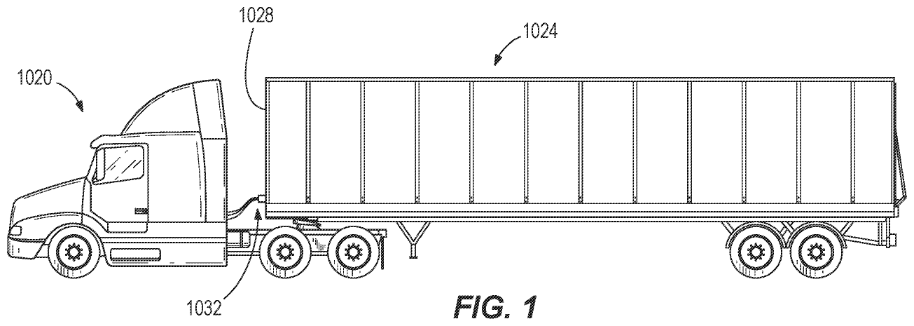

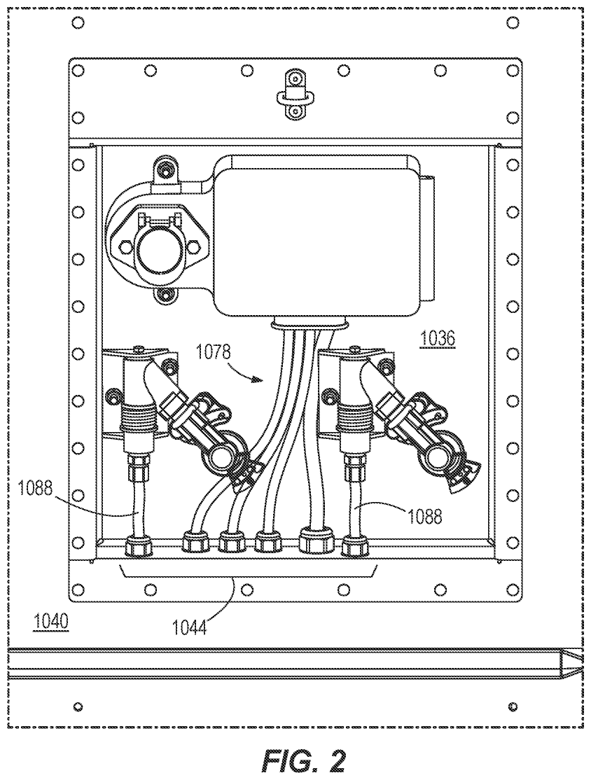

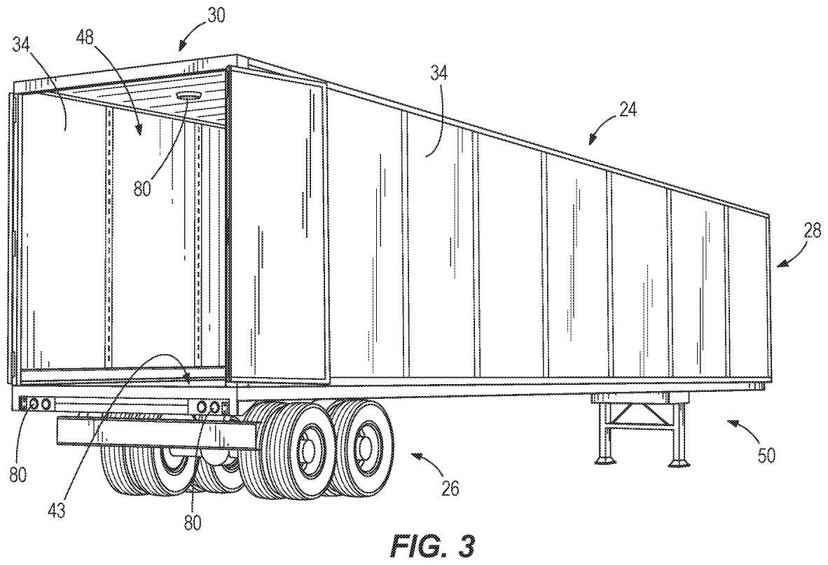

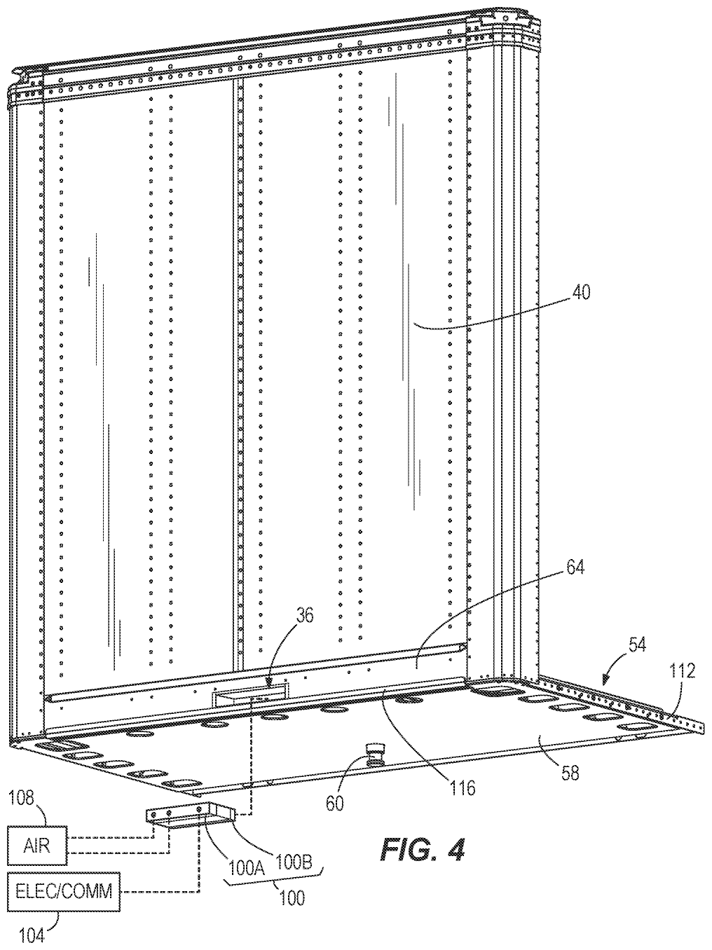

FIGS. 3-10 illustrate a semi-trailer 24 according to one exemplary embodiment of the present disclosure. The semi-trailer 24, which is shown as an enclosed dry van configured for over-the-road use with a road tractor (e.g., Class 8 heavy duty truck like that of FIG. 1 in forming a so-called 18-wheeler) to transport large amounts of cargo. Aspects of the invention may not be limited to such dry van types of semi-trailers, however, and it will be understood that features described herein may also apply to alternate types of semi-trailers (e.g., refrigerated, flatbed, grain hopper, chassis for intermodal containers, etc.). As shown in FIG. 3, the semi-trailer 24 can include a chassis having axles with multiple sets of wheels 26 toward the rear end 30. The semi-trailer 24 defines a length in a longitudinal or transport direction between its front and rear ends 28, 30. The length of the semi-trailer 24 can be 53 feet in some constructions, although the semi-trailer 24 can be manufactured to other lengths greater than or less than 53 feet. Perpendicular to the longitudinal direction, the semi-trailer 24 defines a width and a height. The width cooperates with the length to define a plan view footprint of the semi-trailer 24, while the height is measured perpendicular to the footprint (which can be perpendicular to the ground). The illustrated semi-trailer 24 includes a pair of sidewalls 34, a front wall 40 (FIG. 4), a roof 42, and a load floor 43. A cargo area 48 operable to receive a load of cargo for transport is defined by the sidewalls 34, the front wall 40, the roof 42, and the load floor 43 of the semi-trailer 24. Thus, the cargo area 48 is enclosed in the illustrated construction. Subtracting for wall thicknesses, the length, the width, and the height cooperate to define the interior cargo volume of the semi-trailer 24. At the rear end 30 of the semi-trailer 24 as shown in FIG. 3, an opening for selectively accessing the cargo area 48 is closed by one or more doors. Adjacent the front end 28, the semi-trailer 24 includes landing gear 50 configured to support the front end 28 on a ground surface when the semi-trailer 24 is not coupled to a tow vehicle for transport.

As shown in FIG. 4, the semi-trailer 24 is provided, at the front end 28 and under the load floor 43, with a coupler unit, or simply coupler 54. The coupler 54 is an integrated structural unit within the semi-trailer 24 situated along a front lower portion thereof and having a reinforced box structure. The coupler 54, which fortifies a kingpin 60 thereof, can be constructed separately from the remaining floor structure of the semi-trailer 24 and structurally joined therewith. The coupler 54 includes an upper surface 56 and a lower surface 58 and the kingpin 60 projects downward below the lower surface 58. The upper surface 56 of the coupler 54 defines a floor level of the cargo area 48. Each of the upper and lower surface 56, 58 can be constructed as a continuous plate or sheet, or a combination of elements, some of which may be plates or sheets. In the normal orientation of the semi-trailer 24, the upper and lower surfaces 56, 58 and the coupler 54 overall extend horizontally, and the kingpin 60 extends therefrom vertically downward. Access holes 62 can be provided in either one or both of the upper and lower surfaces 56, 58. The kingpin 60 can be used in establishing the “fifth-wheel” coupling known in the art. Also shown in FIG. 4, the front wall 40 is provided without any recessed cavity or “nosebox” for utility connectors. To facilitate utility connection, a recessed cavity 36 is provided within the coupler 54. The recessed cavity 36 is provided at a central widthwise location. The recessed cavity 36 can be formed as a prismatic open-sided box situated below the upper coupler surface 56. The recessed cavity 36 can be provided entirely below a lower edge of the front wall 40 where the front wall 40 connects with the coupler 54 (e.g., at a vertical front wall 64 of the coupler). The recessed cavity 36 can be of sheet metal construction and may be secured in place by welding as an integral part of the coupler 54.

As shown in FIG. 4, an automatic coupling system 100 is provided for establishing utility line connections (e.g., air and/or electrical) between the tow vehicle and the cargo semi-trailer 24. The coupling system 100 includes a first portion 100A associated with (e.g., supported by, mounted to) the tow vehicle and a second portion 100B associated with (e.g., supported by, mounted to) the cargo semi-trailer 24. The first and second portions 100A, 100B are configured for automatic hook-up without requiring manual actions for making connections. For example, the automatic coupling system 100 can incorporate features of any one or more of U.S. patent Publication 2022/0332158, U.S. Pat. Nos. 11,260,711, 8,177,559, 8,187,020, 7,758,059, 7,793,966, 7,967,319, and 7,854,443, the entire contents of all of which are incorporated herein by reference. As indicated by the facing arrows in FIG. 4, the portions 100A, 100B of the automatic coupling system 100 can be mated together by bringing them together longitudinally (e.g., by rearward movement of the tow vehicle toward the front of the semi-trailer 24). This alone, or a combination of other operations may establish the utility line connections between the tow vehicle and the semi-trailer 24. The automatic coupling system 100, which itself is not the subject of the present disclosure, can also incorporate features of systems later developed in the future. The recessed cavity 36 accommodates the second portion 100B or “trailer-side” of the automatic coupling system 100. As such, the second portion 100B, which makes up one-half of the automatic coupling system 100, can be considered a utility line connection portion of the semi-trailer 24.

Each one of the portions 100A, 100B can include a plurality of individual connectors for a plurality of individual utility line connections, which can include one or more air connections and/or one or more electrical connections. In some constructions, multiple electrical connections can be conglomerated into a single multi-pin connector device, for example a standardized (e.g., SAE, ISO) plug and socket type connector. In some constructions, a 7-wire cable from the tractor may conform to SAE-J1067 and the associated 7-pin connectors may conform to SAE-J560b. An electronic power supply and/or communications module 104 of the tow vehicle is shown schematically in FIG. 4 with the label “ELEC/COMM.” Likewise, an air source or compressor 108 of the tow vehicle is shown schematically in FIG. 4 with the label “AIR.” Electrical lines of the semi-trailer 24 can extend and connect to one or a plurality of electrical devices (e.g., lamps, sensors, and/or actuators) of the semi-trailer 24, the devices and electrical lines constituting an electrical system of the semi-trailer 24. The electrical lines can be connected with various types of lamps 80 of a lighting system, including any or all of taillights, brake lights, marker or clearance lights, and interior dome lights (FIG. 3). Air lines of the semi-trailer 24 can extend and connect to one or a plurality of pneumatic devices (e.g., service brakes and/or parking brake of a brake system, suspension air bags) of the semi-trailer 24.

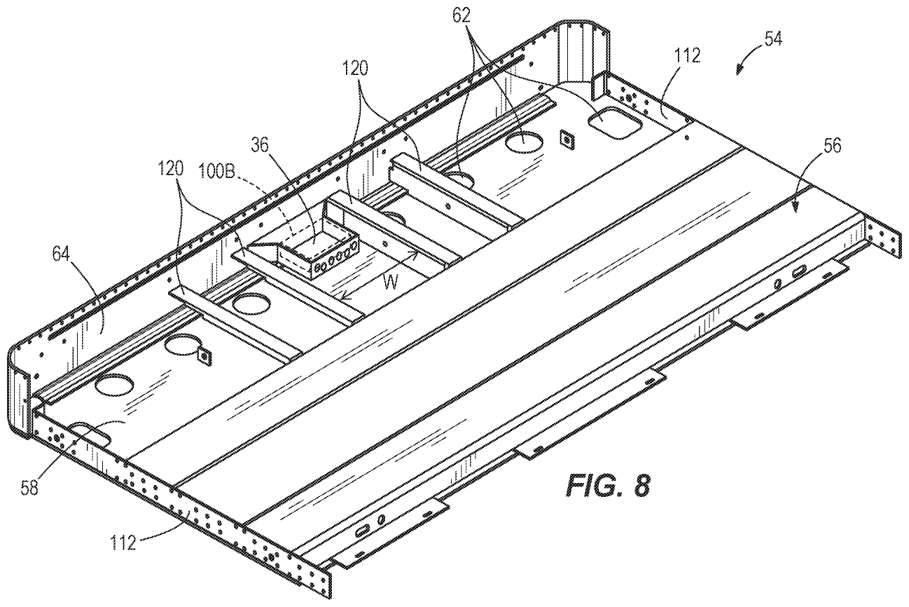

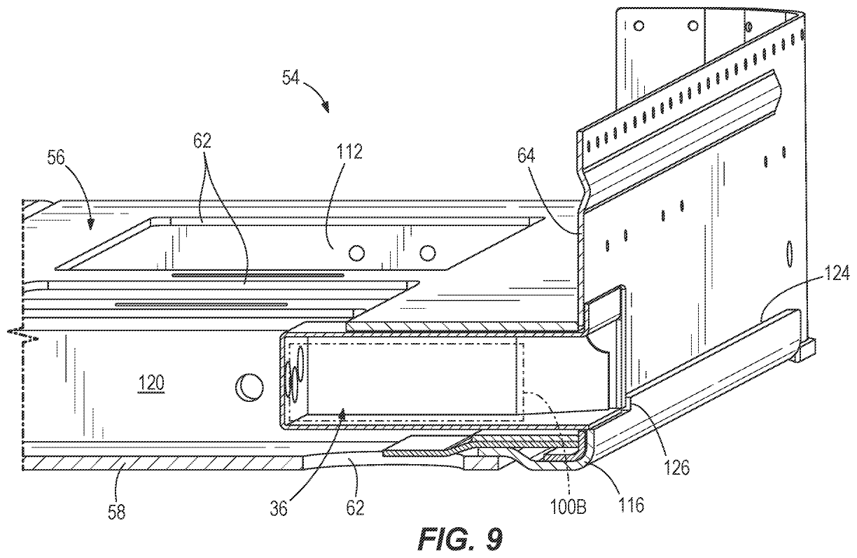

Turning now to the structure of the coupler 54, a weldment is formed by several members including the members making up the upper surface 56 and the lower surface 58, the kingpin 60, the front wall 64, lateral side walls 112, a pick-up lip 116, and a plurality of internal reinforcement members or beams 120. The weldment of the coupler 54 can include more or fewer members than the illustrated construction, with a variety of possible arrangements. The pick-up lip 116 is a wrap-around reinforcement sheet bent around a bottom forward edge of the coupler 54 (also the bottom forward edge of the semi-trailer 24). In other constructions, the pick-up lip can be formed as an integral portion of a bottom plate of the coupler 54, rather than a separate reinforcement. The pick-up lip 116 directly covers and protects the bottom edge of the coupler front wall 64 as can be seen in the cross-section of FIG. 9. The pick-up lip 116 is an exposed exterior portion of the coupler 54 and of the semi-trailer 24. The internal reinforcement members 120 are situated between the upper and lower surfaces 56, 58, rearward of the front wall 64, and between the two lateral side walls 112. As shown in FIG. 8, the internal reinforcement members 120 include a plurality of forward longitudinal reinforcement members 120, two of which are most centrally located—although both are offset from a longitudinally-extending central bisector plane. The two most centrally located forward longitudinal reinforcement members 120 can have a spacing width W (e.g., constant spacing width or a spacing width measured at the forward ends thereof) that is not more than 20 inches in some constructions, or not more than 16 inches. The forward longitudinal reinforcement members 120 can extend exactly longitudinally, and thus parallel to the trailer's longitudinal transport direction, or some/all may be oriented at different angles that still provide a longitudinal span within the coupler 54. The forward longitudinal reinforcement members 120 can have a cross-section shape that is L-shaped, I-shaped, C-shaped, box-shaped, etc.

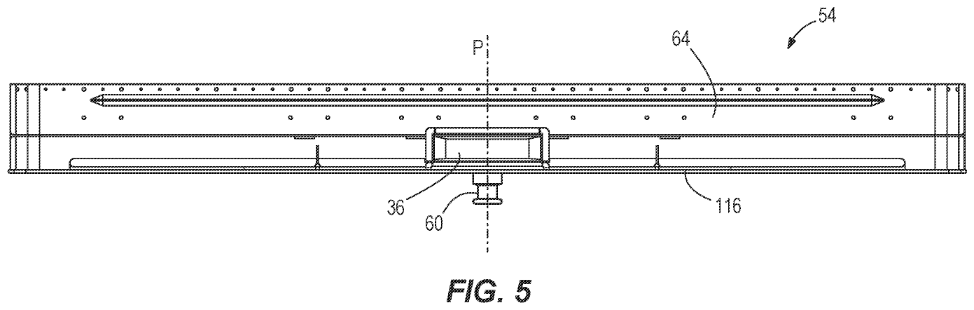

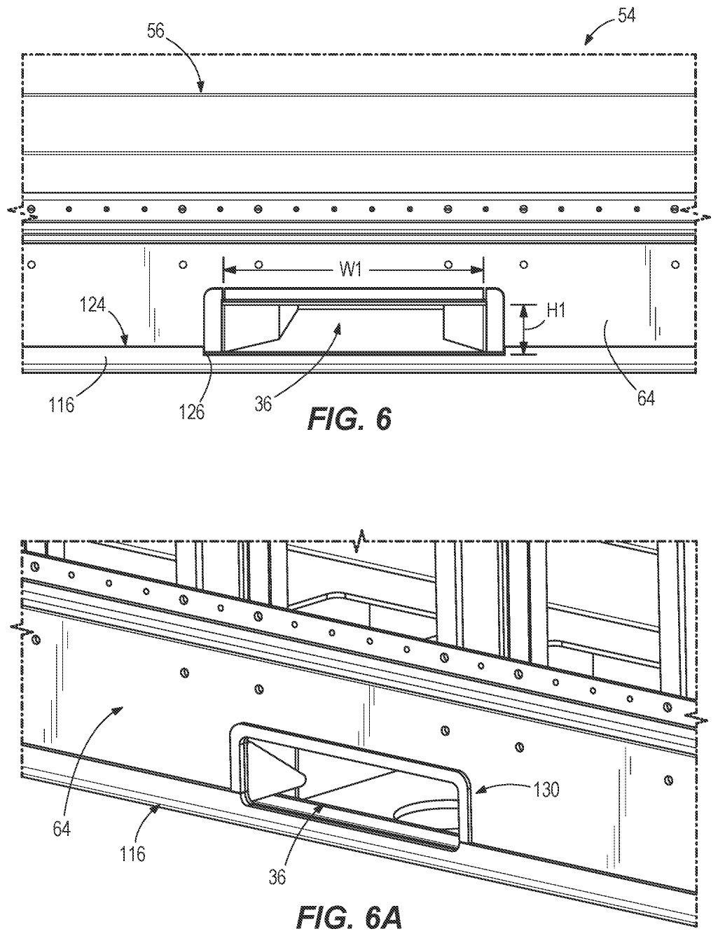

The cavity 36 is constrained to a small frontal area within the coupler front wall 64. The cavity 36 is positioned widthwise centrally, along a laterally central plane (longitudinally extending central bisector plane P, FIG. 5), which intersects the kingpin 60. The cavity 36 can also be defined entirely between the two most central forward longitudinal reinforcement members 120. In the vertical direction, the cavity 36 can be defined entirely between parallel planes defined by the upper coupler surface 56 and the lower coupler surface 58 (e.g., spaced apart and defining a height-wise span not more than 4 inches). In some constructions, the placement of the cavity 36 can be configured to enable the cavity 36 to be retrofit into the coupler 54, or a coupler of another existing construction, without undue weakening of the weldment. For example, material reinforcement may be limited or unnecessary when considering the coupler 54 having the front wall 64 provided without any opening, versus the coupler 54 provided with the opening for the cavity 36. As shown in FIG. 6, the outward portion of the cavity 36 can include sloping or inward-tapered walls, for example on both lateral side walls. Thus, the cavity 36 has a narrowed width toward the rear. In other constructions, the side walls are less tapered or non-tapered (straight longitudinal). Wraparound flanges for the cavity 36 can extend along the forward-facing side of the coupler front wall 64 to set the depth and/or facilitate welding. In other constructions, there are alternate flange configurations or no flanges. In some constructions, as shown in FIG. 6A, a reinforcement frame 130 is provided on the front wall 64 (e.g., metal plate(s) welded onto the front wall 64) directly around the opening of the cavity 36 to form a peripheral frame such that the front wall 64 is suitably strengthened. The reinforcement frame 130 forms either a partial or complete peripheral frame and may join with the pick-up lip 116 as shown in FIG. 6A.

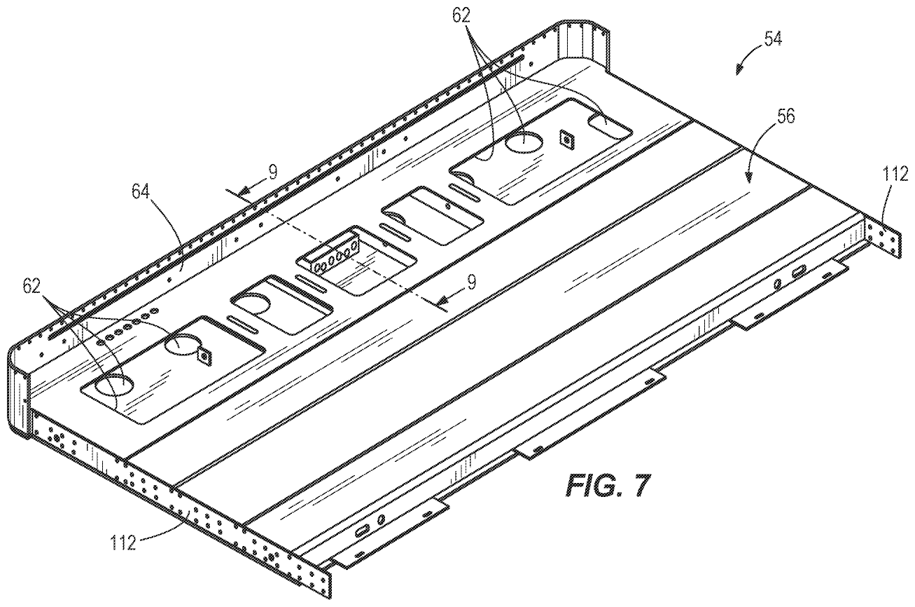

The cavity 36 can have a height H1 of 63.5 mm (2.5 inches) or less and a width W1 of 330 mm (13 inches) or less. In some constructions, the cavity height H1 is less than 51 mm (2.0 inches) and the cavity width W1 is less than 305 mm (12 inches). In some constructions, the cavity height H1 is 47.6 mm (1.875 inches) and the cavity width W1 is 298.5 mm (11.75 inches). The cavity dimensions can be taken at the opening in the front wall 64. The cavity 36 can occupy a majority of the height and/or width defined by the two most centrally located forward longitudinal reinforcement members 120. In some constructions, the cavity 36 (width W1) occupies at least 80 percent or at least 90 percent of the spacing width W of the two most centrally located forward longitudinal reinforcement members 120. The interior corners of the cavity 36 can be rounded, for example with 9.5 mm (0.375 inch) corner radii. As shown in FIGS. 7-9, the rear end (max. depth) of the recessed cavity 36 can include one or more openings for trailer utility lines to be connected to the second portion 100B or “trailer-side” of the automatic coupling system 100. Such connections can be permanent or semi-permanent, not to be confused with the connections made/broken by the two halves of the automatic coupling system 100 during regular coupling/uncoupling with the tow vehicle.

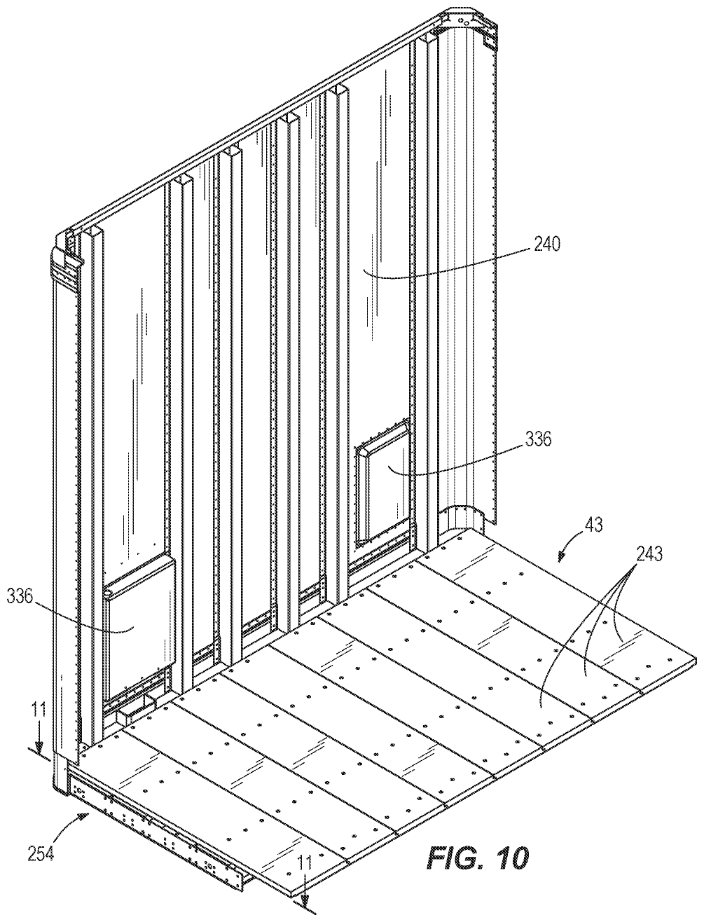

The opening of the recessed cavity 36 for the automatic coupling system 100 is formed in or through the front wall 64 and in or through an uppermost part of the pick-up lip 116. In particular, the pick-up lip 116 includes an upper edge 124 including a cutout portion 126 for the cavity 36. In other words, the pick-up lip 116 has a small amount of height-wise overlap with the cavity 36, the overlap corresponding with the height of the cutout portion 126. The overlap can be less than 12.7 mm (0.5 inch), or less than 6.35 mm (0.25 inch) in some constructions. In other constructions, as detailed below, the opening for the cavity 36 is provided entirely above the upper edge 124 of the pick-up lip 116 (e.g., in the front wall 64 alone). FIGS. 10-12 illustrate one such construction.

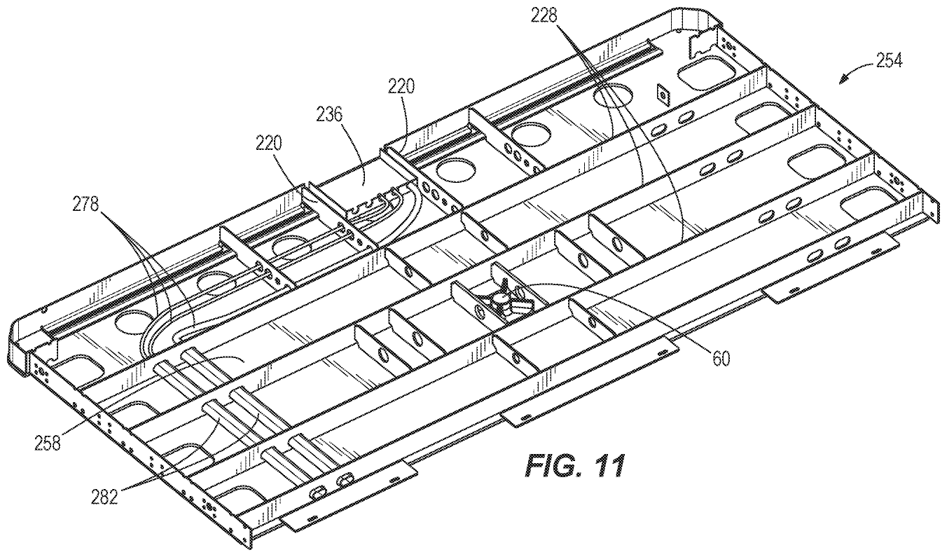

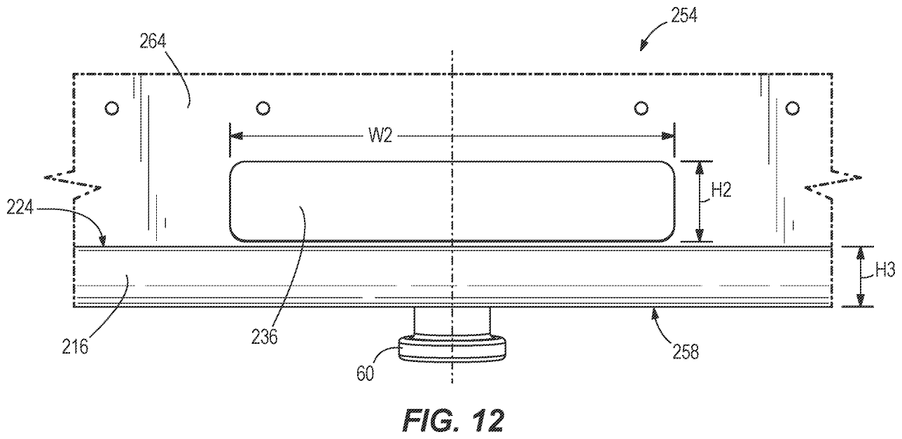

In FIGS. 10-12, an alternate trailer front wall 240 and coupler 254 are illustrated. Specific features thereof which differ from the preceding embodiment are described below, with the understanding that many of the features and uses are the same or similar and thus, not repeated. FIG. 10 illustrates the floor 43 of the cargo area, including several floor planks 243 placed onto the top of the coupler 254 (e.g., directly on the upper surface thereof.) FIG. 11 is a cross-section view illustrating the coupler 254 alone, the section being taken slightly below the upper surface. Several utility lines 278 servicing the air and/or electrical components of the trailer are shown in FIG. 11. It can also be seen from FIG. 11 (with additional reference to FIG. 12) that the recessed cavity 236, although generally in the same central location as the cavity 36, maintains a consistent width W2 along its depth into the coupler 254. One or more of the forward longitudinal reinforcement members 220 can include a plurality of apertures for passage (and organization) of the utility lines 278 along a lateral or widthwise direction. The utility lines 278 can then extend longitudinally through one or more raceways 282, for example to a rear end of the coupler 254. The raceways 282 can intersect one or more transverse reinforcement members 228 of the coupler 254. The utility lines 278 are routed through the coupler 254 exclusively within the height-wise span of the coupler 254, i.e., between the upper coupler surface and the lower coupler surface of the coupler 254.

As shown in FIG. 12, the opening of the cavity 236 is provided in or through the front wall 264 of the coupler 254, entirely above the top edge 224 of the pick-up lip 216. The top edge 224 can maintain the same height position along its entire length, as there is no cutout portion to accommodate the cavity 236. Stated differently, the pick-up lip top edge 224 can be situated at a height H3 above the bottom surface 258 of the coupler 254, and the bottom of the cavity opening can be positioned above the height H3, or further from the bottom surface 258 than the height H3. In some constructions, the height H3 may be less than 63.5 mm (2.5 inches) (e.g., about 38.1 mm (1.5 inches) or about 54 mm (2.125 inches)). The cavity 236 can have a height H2 of 63.5 mm (2.5 inches) or less and a width W2 of 330 mm (13 inches) or less. In some constructions, the cavity height H2 is less than 51 mm (2.0 inches) and the cavity width W2 is less than 305 mm (12 inches). In some constructions, the cavity height H2 is 47.6 mm (1.875 inches) and the cavity width W2 is 298.5 mm (11.75 inches). It will be understood that features of the various embodiments may be combined or isolated in different combinations. With this in mind, it is further noted that the trailer front wall 240 shown in FIG. 10 includes at least one (e.g., two) recessed noseboxes 336, one or both of which may be configured to provide utility line connectors for connection with utility sources of a tow vehicle. For example, a given cargo trailer may be provided with multiple options for utility line connections with tow vehicle(s), and these may include both manually operable connectors and a part of an automatic coupling system that is configured to operate without manual operation. Such a trailer may offer benefits of the automatic coupling system in limited situations or environments that permit completely autonomous coupling of the trailer with a tow vehicle for autonomous driving or movement thereof. For example, in a private logistics facility, autonomous tow vehicles may jockey trailers to different locations (e.g., for loading, unloading, service, etc.) and may utilize the automatic coupling system. Meanwhile, the same trailers may be used, within the same facility and/or out on public roads, with more conventional manual utility line connections, as the fleet of properly equipped tractors and the opportunity to perform autonomous driving tasks may be limited, especially fully autonomous driving for the near future.

The embodiments described above and illustrated in the figures are presented by way of example only and are not intended as a limitation upon the concepts and principles of the present invention. As such, it will be appreciated by one having ordinary skill in the art that various changes in the elements and their configuration and arrangement are possible without departing from the spirit and scope of the present invention as set forth in the appended claims.

What is claimed is:

1. A semi-trailer comprising:
a cargo area;
an integrated fifth-wheel coupler unit extending horizontally along a front lower portion of the semi-trailer and including an upper coupler surface defining a floor level of the cargo area, a lower coupler surface spaced below the upper coupler surface, and a kingpin projecting downwardly from the lower coupler surface and configured for coupling with a fifth wheel of a tow vehicle; and
a utility line connection portion for establishing connections between at least one utility source of the tow vehicle and at least one utility component of the semi-trailer,
wherein the integrated fifth-wheel coupler unit includes a front wall with a recessed cavity at a central widthwise location accommodating the utility line connection portion.

2. The semi-trailer of claim 1, wherein the utility line connection portion includes an electrical connector connected with an electrical line of the semi-trailer configured for one or both of power supply and data communication.

3. The semi-trailer of claim 1, wherein the utility line connection portion includes multiple connectors including air and electrical connectors connected with respective air and electrical lines in the semi-trailer, and the utility line connection portion is one-half of an automatic utility line connection system, wherein brakes of the semi-trailer are configured for operation by the air line and a plurality of lamps of the semi-trailer are configured for operation by the electrical line.

4. The semi-trailer of claim 1, further comprising a front wall having a bottom edge secured to the front wall of the integrated fifth-wheel coupler unit, and the front wall of the semi-trailer is devoid of a utility line nosebox.

5. The semi-trailer of claim 1, wherein the recessed cavity has a height of 63.5 mm (2.5 inches) or less and a width of 330 mm (13 inches) or less.

6. The semi-trailer of claim 1, wherein the recessed cavity has a height less than 51 mm (2.0 inches) and a width less than 305 mm (12 inches).

7. The semi-trailer of claim 1, wherein the recessed cavity is situated longitudinally in-line with the kingpin and centrally between a pair of longitudinally extending reinforcement beams that are situated vertically between the upper coupler surface and the lower coupler surface.

8. The semi-trailer of claim 1, wherein the integrated fifth-wheel coupler unit is a weldment including at least one sheet forming the upper coupler surface, at least one sheet forming the lower coupler surface, a plurality of reinforcement beams between the upper coupler surface and the lower coupler surface, the front wall, and a pick-up lip bent around a bottom forward edge, and wherein an opening of the recessed cavity is formed in the front wall entirely above an upper edge of the pick-up lip.

9. The semi-trailer of claim 1, wherein the integrated fifth-wheel coupler unit is a weldment including at least one sheet forming the upper coupler surface, at least one sheet forming the lower coupler surface, a plurality of reinforcement beams between the upper coupler surface and the lower coupler surface, the front wall, and a pick-up lip bent around a bottom forward edge, and wherein an opening of the recessed cavity is formed in the front wall and an upper cutout portion of the pick-up lip.

10. The semi-trailer of claim 1, wherein utility lines coupled to the utility line connection portion are routed exclusively between the lower coupler surface and the upper coupler surface through the integrated fifth-wheel coupler unit.

11. A semi-trailer comprising:
a front end;
a rear end;
a cargo area defined between the front and rear ends and configured for supporting cargo;
an integrated fifth-wheel coupler unit provided at a bottom of the front end and comprising a reinforced box structure and a downwardly protruding kingpin; and
a recessed cavity provided entirely within the integrated fifth-wheel coupler unit and located at a laterally central plane in-line with the kingpin,
wherein a utility line connection portion that establishes one-half of an automatic utility line connection system is received within the recessed cavity.

12. The semi-trailer of claim 11, wherein the utility line connection portion includes one or both of: an air connector connected with an air line of the semi-trailer to service a brake system, and an electrical connector connected with an electrical line of the semi-trailer to service a lighting system of the semi-trailer.

13. The semi-trailer of claim 11, further comprising a front wall having a bottom edge secured to a front wall of the integrated fifth-wheel coupler unit, and the front wall of the semi-trailer is devoid of a utility line nosebox.

14. The semi-trailer of claim 11, wherein the recessed cavity has a height of 63.5 mm (2.5 inches) or less and a width of 330 mm (13 inches) or less.

15. The semi-trailer of claim 11, wherein the recessed cavity has a height less than 51 mm (2.0 inches) and a width less than 305 mm (12 inches).

16. The semi-trailer of claim 11, wherein the recessed cavity has a width that occupies at least 80 percent of a widthwise spacing between a pair of longitudinally extending reinforcement beams at a front of the integrated fifth-wheel coupler unit.

17. The semi-trailer of claim 11, wherein the integrated fifth-wheel coupler unit includes a pick-up lip bent around a bottom forward edge, and wherein an opening of the recessed cavity is formed in a front wall of the integrated fifth-wheel coupler unit entirely above an upper edge of the pick-up lip.

18. The semi-trailer of claim 11, wherein the integrated fifth-wheel coupler unit includes a pick-up lip bent around a bottom forward edge, and wherein an opening of the recessed cavity is formed in a front wall of the integrated fifth-wheel coupler unit and partially defined by an upper cutout portion of the pick-up lip.

19. The semi-trailer of claim 11, wherein utility lines coupled to the utility line connection portion are routed exclusively between a lower coupler surface and an upper coupler surface through the integrated fifth-wheel coupler unit.

20. A semi-trailer comprising:
a cargo area including a floor;
an integrated fifth-wheel coupler unit supporting the floor at a front end of the semi-trailer;
a recessed cavity provided in a front central portion of the integrated fifth-wheel coupler unit; and
a utility line connection portion secured within the recessed cavity,
wherein the recessed cavity has a height of 63.5 mm (2.5 inches) or less and a width of 330 mm (13 inches) or less, and
wherein the integrated fifth-wheel coupler unit includes a pick-up lip bent around a bottom forward edge, and an opening of the recessed cavity is formed in a front wall of the integrated fifth-wheel coupler unit entirely above an upper edge of the pick-up lip.
